(19) United States
(12) Patent Application Publication
(10) Pub. No.: US 2016/0125423 A1
(43) Pub. Date: May 5, 2016

(54) Managing Customs Information

(71) Applicants: Ehab Mahmoud Ahmed NOUR, Tebal Ali, Dubai (AE); John Alan GROSZ, Missouri City, TX (US); James Alan BIELEFELDT, Cypress, TX (US); Robert Lynn HARMON, Katy, TX (US); John Joseph VOGT, Katy, TX (US); HALLIBURTON ENERGY SERVICES INC., Houston, TX (US)

(72) Inventors: Ehab Mahmoud Ahmed Nour, Tebal Ali (AE); John Alan Grosz, Missouri City, TX (US); James Alan Bielefeldt, Cypress, TX (US); Robert Lynn Harmon, Katy, TX (US); John Joseph Vogt, Katy, TX (US)

(73) Assignee: Halliburton Energy Services, Inc., Houston, TX (US)

(21) Appl. No.: 14/889,992

(22) PCT Filed: Jul. 22, 2013
(86) PCT No.: PCT/US2013/051483

§ 371 Date: Nov. 9, 2015

(51) Int. Cl. G06Q 30/00; G06Q 10/08

(52) U.S. Cl. CPC G06Q 30/018; G06Q 10/0831

(57) ABSTRACT

A broker management computer system (“BMCS”) receives from a logistics computer system (“LCS”) information regarding an asset to be imported into a country. The BMCS creates an initial import record in a BMCS database. The initial import record includes information regarding the asset and a unique BMCS control number generated by the BMCS. The BMCS issuing an initial import packet including the BMCS control number and provides the initial import packet to an import broker in the country. The BMCS receives from the import broker a customs packet including documents that show that the asset has cleared customs in the country, a declaration number, and the BMCS control number. The BMCS searches the BMCS database using the BMCS control number as a key for the search, finds the initial import record, and updates the initial import record with the declaration number.

### BACKGROUND

Enterprises that work in an international environment often find it useful to, for example, temporarily import equipment into a country for use for a period of time and then export the equipment for use in another country. For example, oil service companies may wish to temporarily import well logging equipment, such as a logging truck or a logging tool, into a country, leave it in that country for a few months or years, and then export it for use in another country.

Customs authorities collect customs duties when an asset is imported into a country. The amount of such duties varies in many countries depending on the value of the imported asset and the type of import. The duties charged for a Temporary import, i.e., an import in which an importer plans to remove the asset after a period of time, are often different from the duties charged for a Definitive import, i.e., a permanent import in which an importer plans to leave the asset in the country permanently. A customs authority may require an importer to prove that an asset imported as a Temporary import has been removed from a country or that it has been lost or destroyed in the country. Failure to produce the documents necessary to make such proof, even if the asset has actually been removed from the country, may result in the importer paying the higher duties usually required for a Definitive import as well as fines that may be assessed.

Government issued customs documents are issued for equipment and/or materials brought in to a country or moved around a country. Typically, one document is issued on import indicting the status of the import (i.e., Temporary or Definitive) and that the required duties or fees have been paid. Typically, at the time of export (for Temporary imports), another document is issued or the original import document is stamped showing that the equipment or materials have left the country. Additionally, special customs documentation may be required for a return-to-repair export, in which equipment is returned to a manufacturer or repair center for repair with the intent that it will be brought back to the country.

An importer may hire a broker in a country to manage the customs documentation associated with the importer's assets in that country. Relying on the record-keeping of the broker for a large number of assets to avoid paying unintended duties can be risky and limits the company's ability to change brokers.

### BRIEF DESCRIPTION OF THE DRAWINGS

FIG. 1 illustrates the process for creating an original import packet.

FIGS. 2-10 are screen shots illustrating the creation of the Broker Summary.

FIG. 11 illustrates creation of an original import packet.

FIG. 12 illustrates the process for creating a change declaration packet.

FIGS. 13-17 illustrate creation of various change declaration packets.

FIG. 18 illustrates a relationship between an initial import record and child records in a database.

FIG. 19 is a flow chart.

### DETAILED DESCRIPTION

A Broker Management Computer System (“BMCS”) provides a centralized document repository with customs declaration tracking ability to reduce liability with customs authorities globally and to ensure that document retention meets country customs retention laws and company retention policy.

In one embodiment, a logistics computer system (“LCS”) reduces the steps a user takes to create a customs transaction to bring equipment/material in country. In one embodiment, LCS integrates multiple modules of a commercially-available logistics computer system, such as those provided by SAP®, to and/or software code that has been internally developed by a company around or in the environment of the commercially-available logistics computer system to serve the needs of a company. For example, in one embodiment, BMCS provides the ability to access data about assets from an Asset Management Integration (“AMI”), which is internally developed code (i.e., code developed by the assignee of the instant patent application) in the SAP® environment that allows data about an asset to be accessed using a shipping invoice number for that asset, so that independent entry of that information is not necessary.

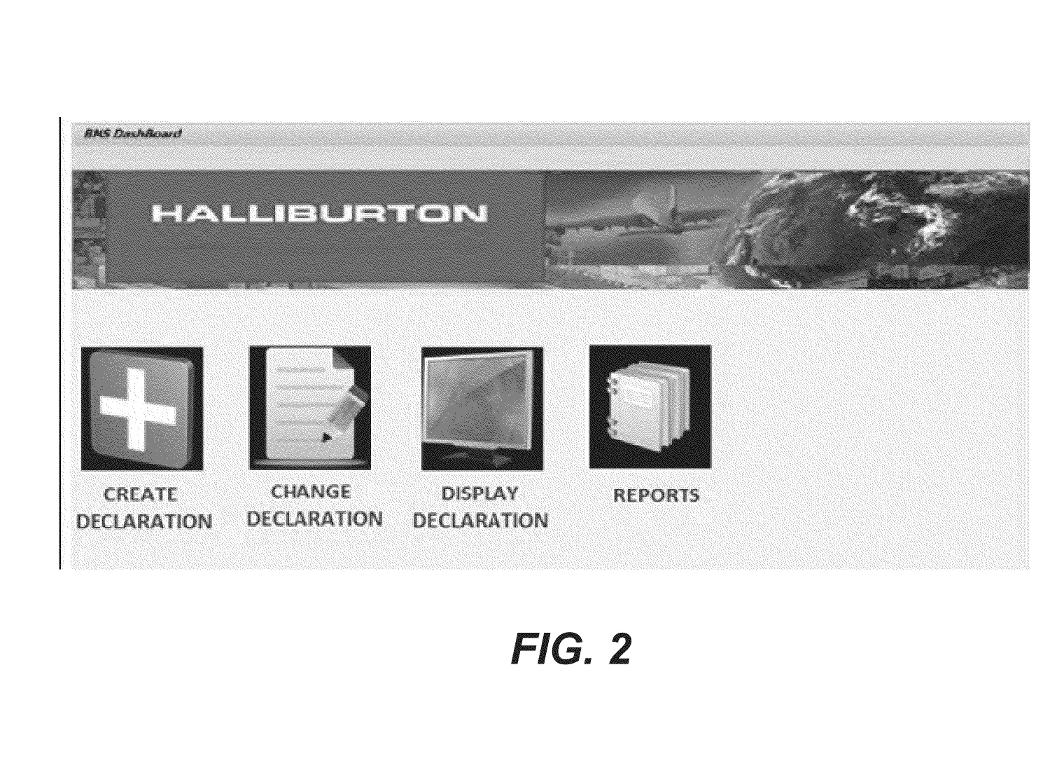

In one embodiment, BMCS provides a dashboard interface, discussed below in connection with FIG. 2, that allows a user to record Definitive, Temporary, Bonded, and Temporary Export customs declarations. In one embodiment, the dashboard interface allows a user to initiate an import or to change an existing declaration. In one embodiment, much of the data required for such imports is imported from LCS, minimizing user interaction and reducing the possibility of error. In one embodiment, once the information is entered, BMCS will allow the user to send clearance instructions to the broker and, once customs is cleared, full customs entry documents will be returned and uploaded into a document repository.

In one embodiment, BMCS provides comprehensive reporting for monitoring and auditing the customs status of an asset throughout the life of a customs declaration.

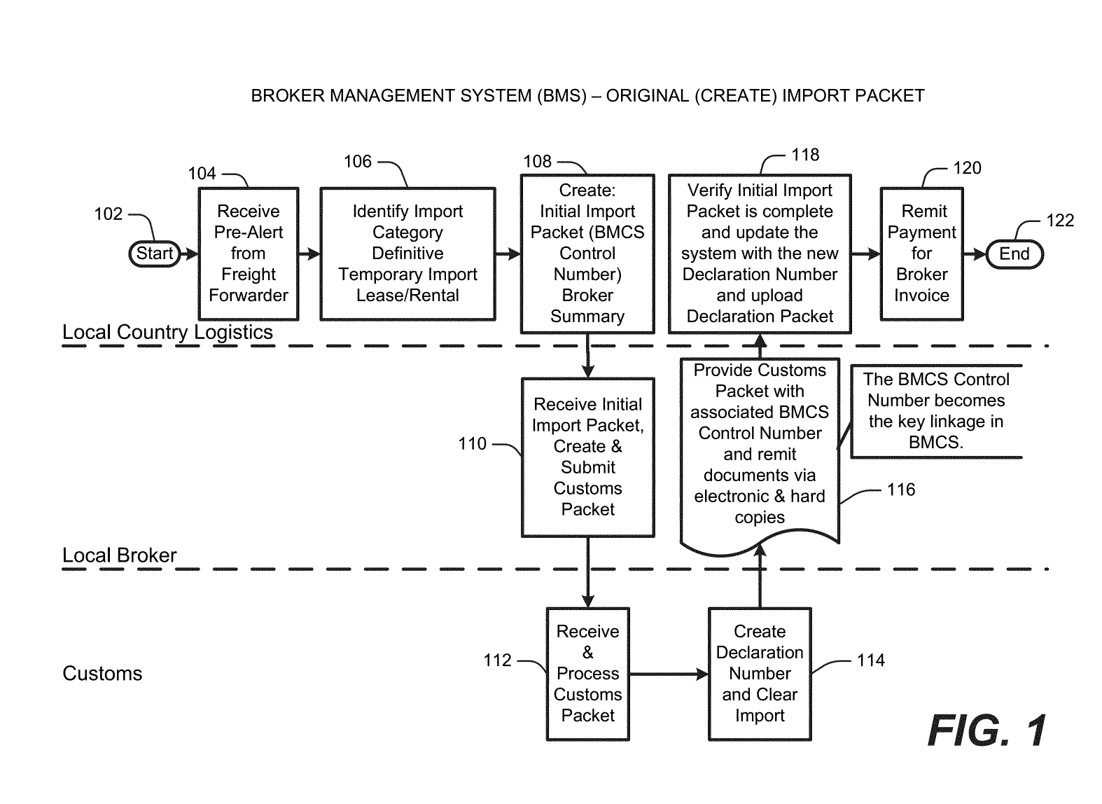

The workflow for creating an original import package is illustrated in FIG. 1. FIG. 1 is divided horizontally into three sections to illustrate the activities of local country logistics (in the top section), a local broker (in the middle section), and customs (in the bottom section).

In one embodiment, the workflow begins (block 102) when a pre-alert is received from a freight forwarder (block 104). In one embodiment, such a pre-alert indicates that an asset or a set of assets is about to be taken into a country. Henceforth, this application will describe the BMCS operations concerning one asset. It will be understood that the same operations can be performed with a plurality of assets.

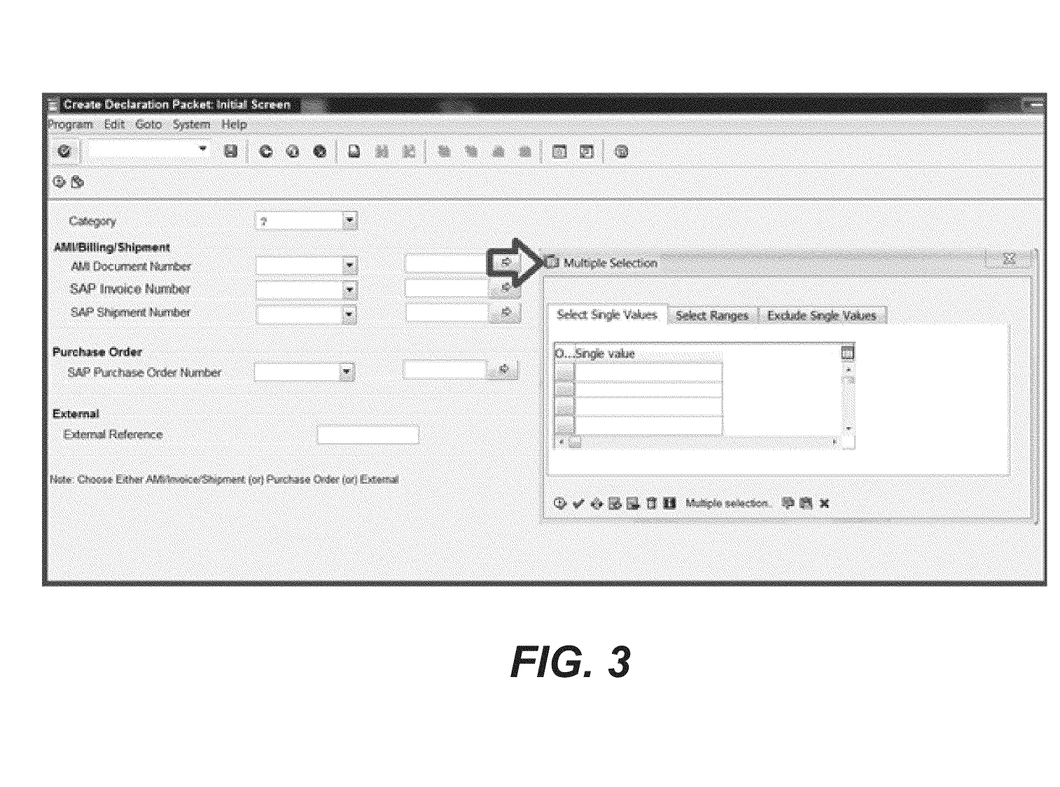

In one embodiment, a user will access a BMCS dash board on a computer display screen, illustrated in FIG. 2 (note that FIG. 2 is labeled “BMS Dash Board”; “BMS” refers to Broker Management System and, for the purposes of this patent application, is equivalent to “BMCS”), and select “Create Declaration.” That selection will initiate the creation of the initial import packet, which includes the creation of the BMCS Control Number and the creation of the Broker Summary, (block 108), causing the “Create Declaration Packet: Initial Screen,” illustrated in FIG. 3, to be displayed.

In one embodiment, the pre-alert includes a reference that can be used to retrieve information about the asset. In one embodiment, the reference is a LCS (e.g., SAP®) billing or shipping number that can be an AMI document number, an invoice number, or a shipment number. In one embodiment, the reference is a SAP® purchase order number. In one embodiment, the reference is an external reference, such as a vendor invoice for a sample purchased on a procurement card, not on a SAP® purchase order.

In one embodiment, the user uses the reference to make one of the selections shown in FIG. 3, and that selection causes additional information about the asset to be retrieved from LCS (e.g., SAP®) or another external reference source. In one embodiment, the additional information includes such information as a material number, a material description, an equipment description, a vehicle identification number (“VIN”), a vehicle manufacture date, a quantity, a unit of measure (“UOM”), an invoice value, a currency type, a contract number, a customer name, a business unit identifier, a cost center, and various other similar information.

In one embodiment, the “category” pull-down menu shown on the screen in FIG. 3 allows the user to specify the import category as a Definitive import, a Temporary import, or a Lease/rental (or bonded) import (block 106). In one embodiment, if the user specifies a Temporary import, the user further specifies one of the following “regimes” for the Temporary import: Temporary Import Standard, Temporary Import Product Sharing Agreement, Temporary Import No Product Sharing Agreement, Temporary Import Repetro, Temporary Import Commodato.

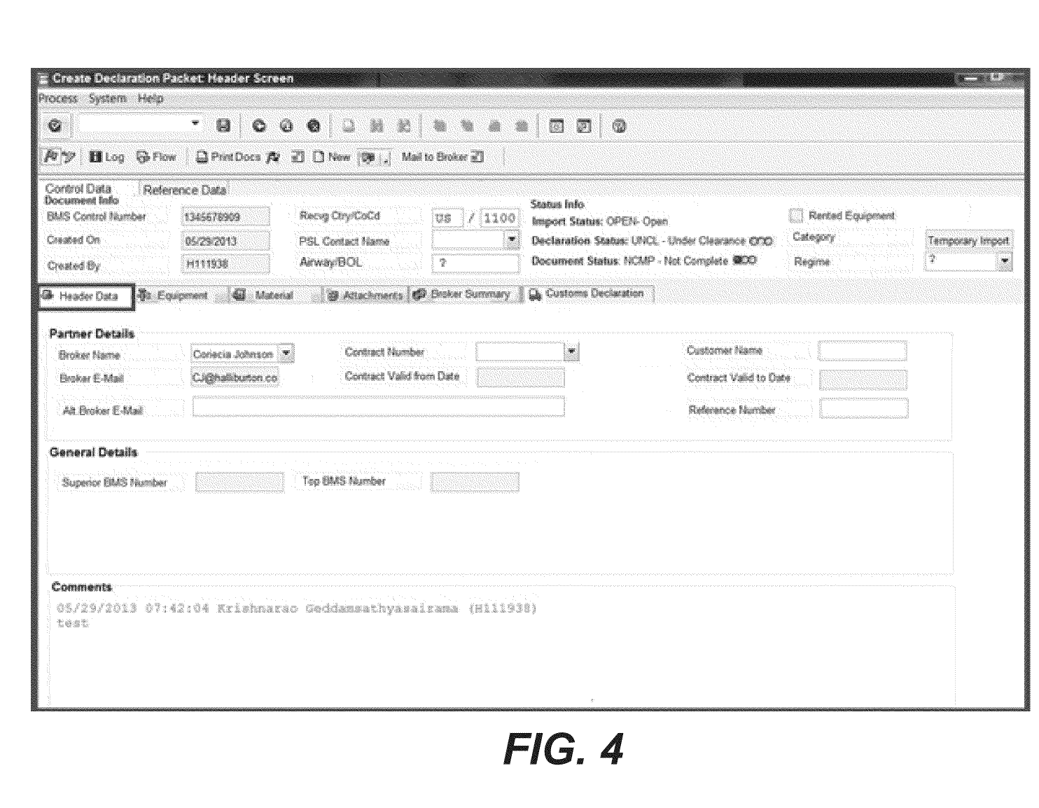

In one embodiment, once the selections on FIG. 3 are made, the BMCS allows the user to create an initial import packet (block 108), using the “Create Declaration Packet” screen shown in FIG. 4. In one embodiment, the screen shown in FIG. 4 has several tabs: a “Control Data” tab, a “Reference Data” tab, a “Header Data” tab (which is currently displayed on FIG. 4), an “Equipment” tab, a “Material” tab, an “Attachments” tab, a “Broker Summary” tab, and a “Customs Declaration” tab.

In one embodiment, the “Control Data” tab includes a “BMCS Control Number” field which is populated automatically with a unique “BMCS Control Number.” In one embodiment, the “BMCS Control Number” is permanently assigned to the asset in BMCS and is used to identify and track the asset while it is in the country and thereafter.

In one embodiment, the “Control Data” tab includes a “Created On” field that contains the date the BMCS control number was created, a “Created By” field that contains an identifier for the person that created the declaration packet, a “Recvg Ctry” field that contains a letter code for the receiving country, a “CoCd” field that contains a numeric code for the receiving country, a “PSL Contact Name” field that contains the name of the business unit contact person for the asset, and an “Airway/BOL” field that contains a code for the air way bill or bill of lading for the asset. In one embodiment, some or all of these fields are automatically filled from LCS (e.g., SAP®).

In one embodiment, the Control Data tab includes status information (“Status Info”) about the Declaration Packet being processed. In one embodiment, the status information includes an “Import Status” field which can have the following values: “Pending” (if the Broker Summary is being prepared), “Open” (if the Broker Summary has been sent to the broker), or “Closed” (if the “Declaration Status” field, discussed below, is set to “Complete”).

In one embodiment, the status information includes a “Declaration Status” field, which includes a “traffic light” (illustrated in FIG. 4 as three adjacent circles). In one embodiment, the “Declaration Status” field can have the following values (with the traffic light status in parentheses after the value): “Under Clearance” (no light, if the Broker Summary has been sent but the Declaration information has not been updated or attached), “Active” (green, only applicable for Temporary Imports, if the Declaration information has been updated and attached), “Expired” (only applicable for Temporary Imports, yellow if the current date is 30 days prior to expiration, red if expiration has passed), or “Complete” (blue or no light). In one embodiment, the Declaration Status field indicates “Complete” only when the following information is updated/attached:
Custom Declaration Number
Declaration From Date
Declaration Value
Total Duty Amount

Attachments:
AWB/BOL
Commercial Invoice
Customs Declaration
Customs Release
   Further, in one embodiment, for a Temporary Import, the Declaration Status field indicates “Complete” only when the above conditions are met that all parent/child transactions (described below) are in a final status (i.e., Lost-in-Hole, Damaged/Scrap, or Export).

In one embodiment, the status information includes a “Document Status” field, which includes a “traffic light” (illustrated in FIG. 4 as three adjacent circles). In one embodiment, the “Document Status” field can have the following values (with the traffic light status in parentheses after the value): “Upload Complete” (green, if all required documents for the transaction have been uploaded/attached), or “Not Upload” (red, if all required documents for the transaction have not been uploaded/attached).

Thus, in one embodiment, the status of the Declaration Packet being processed can be ascertained by glancing at the Control Data tab. That is, in one embodiment, the Declaration Packet is complete or on track if all lights are green or if no lights are illuminated. In one embodiment, there is a problem or potential problem with the Declaration Packet being processed if any of the lights are yellow or red. In one embodiment, the problems can be investigated by clicking on one of the other tabs, as discussed below.

In one embodiment, the “Reference Data” tab displays the information submitted on the initial screen illustrated in FIG. 3.

In one embodiment, the “Header Data” includes a “Partner Details” area, a “General Details” area, and a “Comment” field.

In one embodiment, the “Partner Details” area includes a “Broker Name” field that includes the name of a broker chosen from a drop down list of brokers in the receiving country, a “Broker E-mail” field that contains the e-mail address of the selected broker, and an “Alt. Broker E-mail” field that contains an alternative e-mail address for the selected broker. In one embodiment, the “Partner Details” area includes a “Contract Number” field that contains an identifier for the contract under which the asset covered by the Declaration Packet is being imported as selected using a drop down list of contract numbers, a “Contract Valid from Date” field that contains the date that the selected contract became valid, a “Contract Valid to Date” field that contains the date that the selected contract expires, a “Customer Name” filed that contains the name of the customer to whom the service is being sold, and a “Reference Number” field that contains user-selected free form text.

In one embodiment, the “General Details” contains a “Superior BMS Number” field that contains a next level number under the parent in the hierarchy (child) indicating the previous change. and a “Top BMS Number” field that contains the ultimate top level number in the hierarchy (parent) when creating imports.

In one embodiment, the “Comments” field contains user comments with a user identification and a date-or-time stamp.

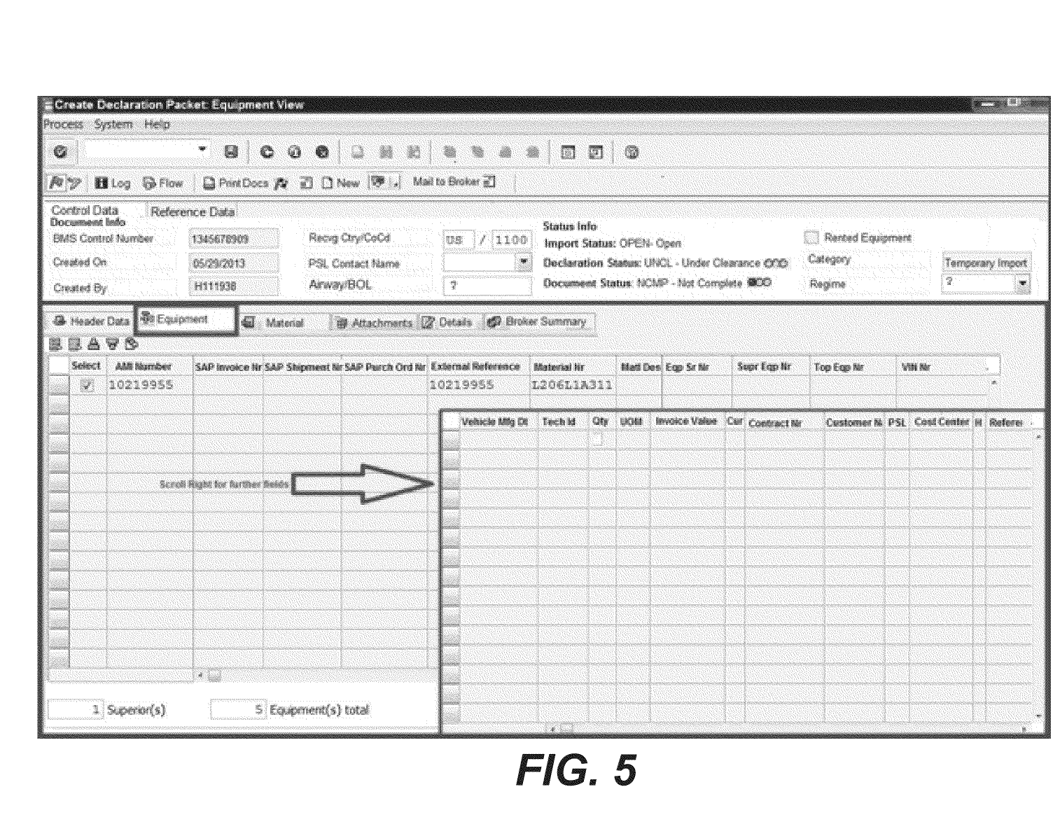

In one embodiment, the “Equipment” tab, illustrated in FIG. 5, allows the user to select the equipment that will be included under this Declaration Packet. In one embodiment, the “Equipment” tab lists equipment associated with the reference entered or selected through the initial screen illustrated in FIG. 3 with information (e.g. “AMI Number,” “SAP Invoice Number,” “SAP Shipment Number,” etc.) pulled from LCS (e.g., SAP®). In one embodiment, the “Equipment” tab includes a “Select” box next to each listed item of equipment. In one embodiment, if the “Import Status” in the “Control Data” area is “Pending,” the user can select the Equipment to be included in the Declaration Packet using the “Select” boxes. In one embodiment, if the “Import Status” in the “Control Data” area is “Open” or “Closed,” no further selection is possible.

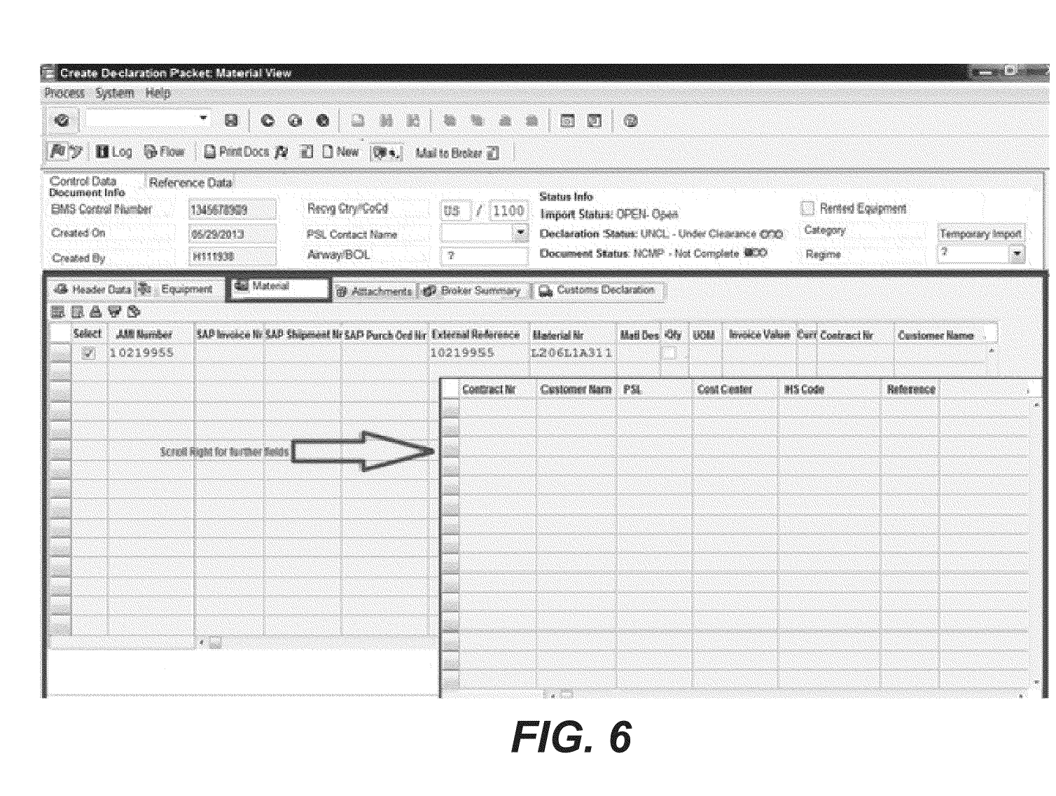

In one embodiment, the “Material” tab (which is available for the “Definitive” and “Bonded” import categories but not for the “Temporary Import” category), illustrated in FIG. 6, allows the user to select the material that should be imported under this Declaration Packet. In one embodiment, the “Material” tab lists equipment associated with the reference entered or selected through the initial screen illustrated in FIG. 3 with information (e.g. “AMI Number,” “SAP Invoice Number,” “SAP Shipment Number,” etc.) pulled from LCS (e.g., SAP®). In one embodiment, the “Material” tab includes a “Select” box next to each listed item of material. In one embodiment, if the “Import Status” in the “Control Data” area is “Pending,” the user can select the Material to be included in the Declaration Packet using the “Select” boxes. In one embodiment, if the “Import Status” in the “Control Data” area is “Open” or “Closed,” no further selection is possible.

In one embodiment, each Equipment and Material item can have one of the statuses listed in Table 1:

TABLE 1

| Status Code | Status Description |
|---|---|
| LIH | Lost in Hole |
| DMG | Damage/Scrap |
| EXP | Export |
| TRNF | Transfer |
| REN | Renew/Extend |
| TDEF | Temp to Definitive |

In one embodiment, if an entry is made in the “External Reference” field on the “Initial Screen” (see FIG. 3), an “External Reference” tab will appear on the “Create Declaration Packet” screen (FIG. 4) and provide a form for the user to enter or add information such as that listed above for the “Equipment” and “Material” tabs for external equipment and materials.

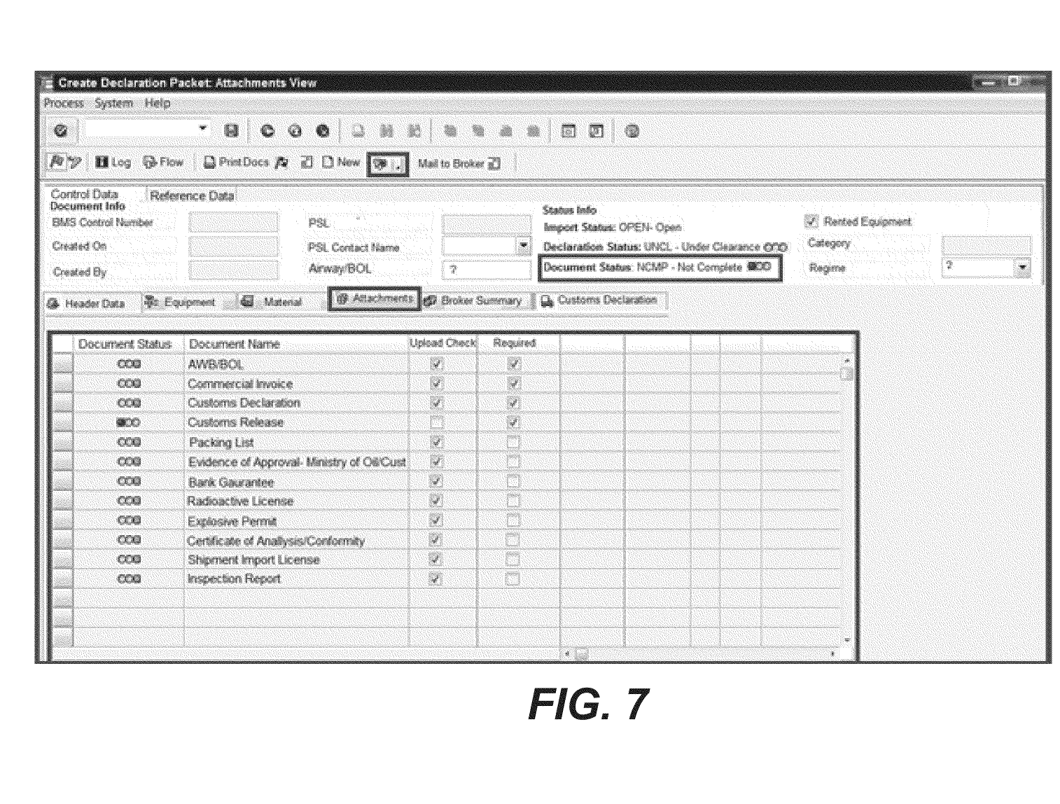

In one embodiment, the “Attachments” tab, illustrated in FIG. 7, provides a list of documents associated with the Declaration Packet. In one embodiment, each of the listed documents has an “Upload Check” box, a “Required” box and a “Document Status” traffic light (indicated by the three circles adjacent the document name under the “Document Status” heading).

In one embodiment, the user will click on the “Required” box for a document if upload of the document is required to turn the “Document Status” traffic light green on the “Control Data” tab. The user checks the “Upload Check” box for a document upon uploading the document. A document is uploaded by clicking on the document in the “Document Name” column and clicking on the Upload button (the button has the appearance of a conversation bubble) on the tool bar. The upload status of a document does not affect the status of the “Document Status” traffic light on the “Control Data” tab if the “Required” box for a document is not checked. The “Document Status” traffic light on the “Control Data” tab will turn green if the “Upload Check” box is checked for each document having a checked “Required” box. In the example shown in FIG. 7, the “Document Status” traffic light on the “Control Data” tab is red because the “Customs Release” document, which has a checked “Required” box, does not have a checked “Upload Check” box. The “Document Status” traffic light on the “Control Data” tab will turn green when the “Customs Release” document is uploaded and the “Upload Check” box is checked.

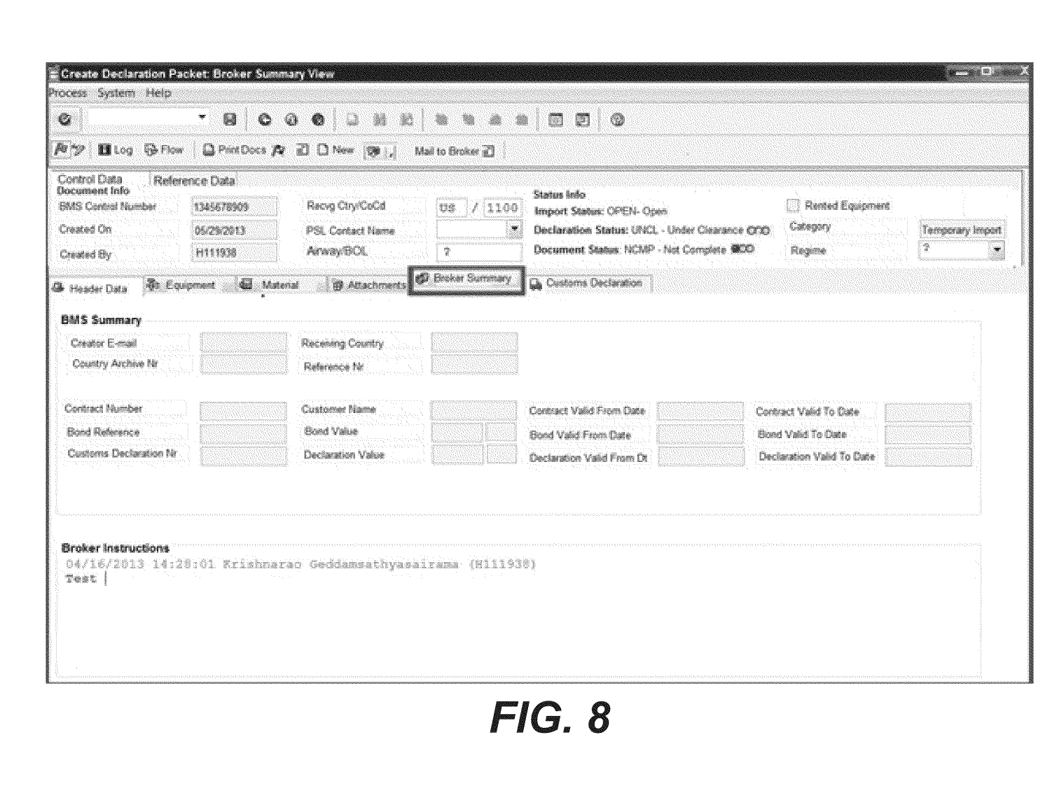

In one embodiment, the “Broker Summary” tab, illustrated in FIG. 8, includes a “BMS Summary” area that provides a different set of entry fields depending on the “Category” selection made on the “Initial Screen” shown in FIG. 3 according to Table 2:

TABLE 2

| Field Name | Definitive | Temporary | Bonded |
|---|---|---|---|
| BMS # | x | x | x |
| Category | x | x | x |
| Regime | | x | |
| Receiving Country | x | x | x |
| Create Date | x | x | x |
| Created By | x | x | x |
| Creator E-Mail | x | x | x |
| SAP Shipment Invoice(s) | x | x | x |
| Contract Number | | x | |
| Customer Name | | x | |
| Contract Valid From Date | | x | |
| Contract Valid To Date | | x | |
| Bond Reference | | x | |
| Bond Value | | x | |
| Bond Valid From Date | | x | |
| Bond Valid To Date | | x | |
| Currency Type | | x | |
| Airway Bill/BOL | x | x | x |
| Country Archive Number | x | x | x |
| Reference (Optional) | x | x | x |
| Broker Instructions | x | x | x |

In one embodiment, the “Broker Summary” includes a “Broker instructions” area where the user can record comments with a user identification and date and time stamp.

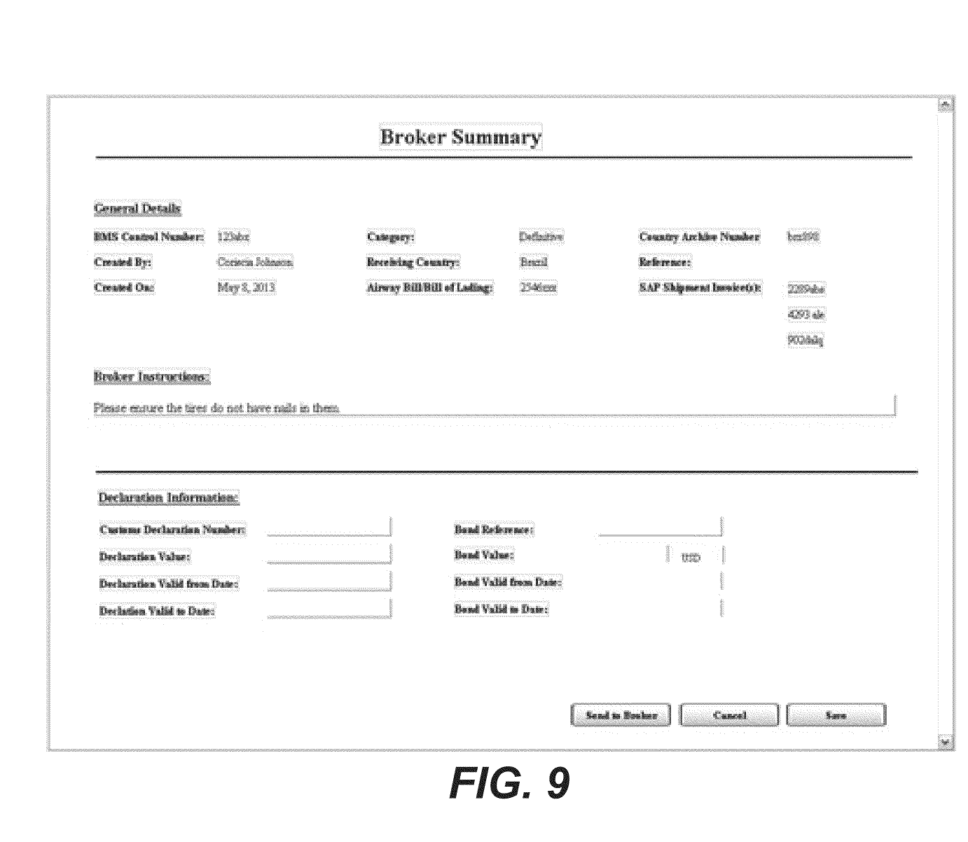

FIG. 8 shows one embodiment of the data entry fields for a Temporary Import (as indicated by the “Category” field in the “Control Data” tab). In one embodiment, after filling in the fields in the “BMS Summary” area, the user will click on the “Mail to Broker” button on the tool bar, which will cause the document shown in FIG. 9 to be displayed. In one embodiment, after review, the user can click the “Send to Broker” button, causing displayed document to be sent to the broker by email to the address filled in on the “Header” tab, “Cancel” button, which causes the display to return to that shown in FIG. 8, or the “Save” button causing the information shown on FIG. 8 to be saved for later editing.

In one embodiment, the form shown in FIG. 9 has fields to be filled in by the broker, with the set of broker-fillable fields included on the form being different depending on the “Category” selection made on the “Initial Screen” shown in FIG. 3 according to Table 3:

TABLE 3

| Broker-Fillable Field Name | Definitive | Temporary | Bonded |
|---|---|---|---|
| Customs Declaration Number | x | x | x |
| Declaration Value | x | x | x |
| Declaration Valid From Date | | x | x |
| Declaration Valid To Date | | x | x |
| Declaration Date | x | | |
| Duties Amount | x | x | |
| Currency Type | x | x | x |
| Bond Reference | | x | |
| Bond Amount | | x | |
| Bond Valid From Date | | x | |
| Bond Valid To Date | | x | |

Returning to FIG. 1, the local broker receives the initial import packet and creates and submits a customs packet for the asset to customs (FIG. 1, block 110).

Customs receives and processes the customs packet (block 112) and creates a declaration number, clears the asset for import (block 114) and provides the import documents to the broker.

The broker provides BMCS with a custom packet, with the broker-fillable fields in the form shown in FIG. 9 completed, and the BMCS “Control Number,” which is one of the previously-filled fields in the form shown in FIG. 9, remitting the customs documents electronically and in hard copy (block 116).

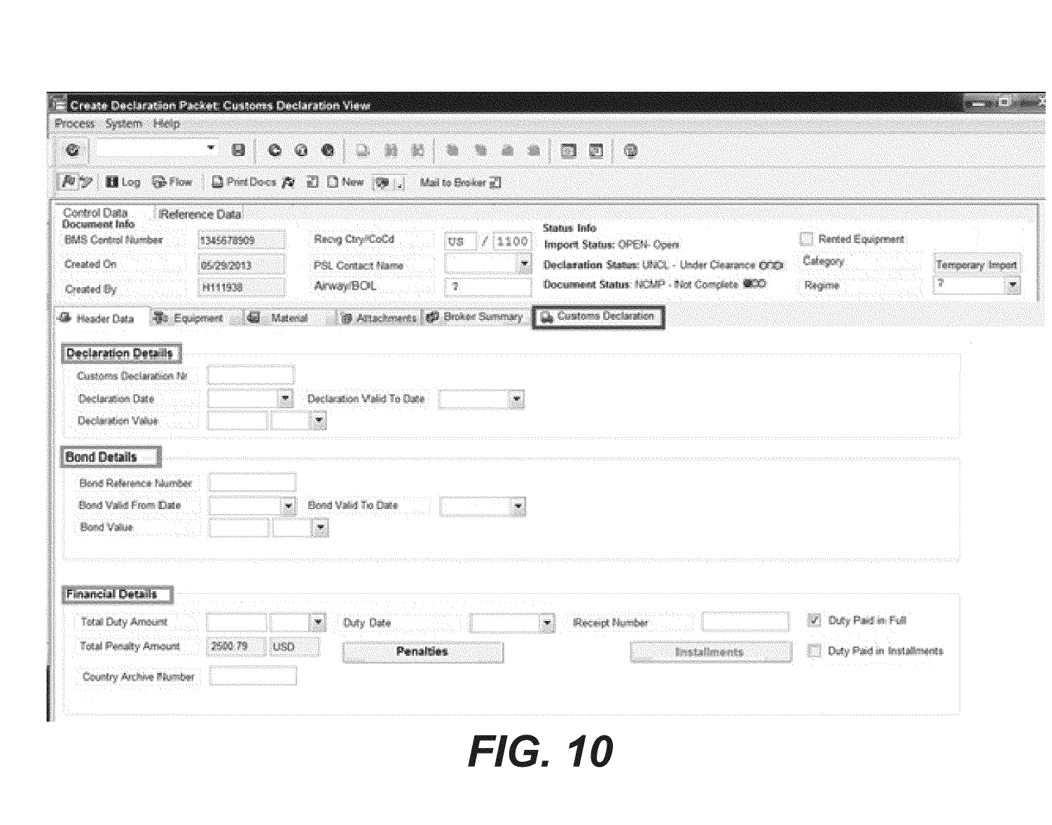

In one embodiment, the “Customs Declaration” tab, shown in FIG. 10, includes fields that are automatically filled from the returned form. In one embodiment, the fields are manually filled using information from the returned form.

In one embodiment, the “Customs Declaration” tab will include only the fields applicable for the “Category” selected for on the “Initial Screen” (FIG. 3) as listed in Table 3.

Returning to FIG. 1, in one embodiment, BMCS verifies that the Initial Import Packet is complete, updates BMCS with the new Declaration Number, and uploads the Declaration Packet (block 118).

In one embodiment, having ascertained that the Initial Import Packet is complete, and only if it is complete, BMCS remits payment to the broker (block 122). In general, in one embodiment, a broker is not paid until the information necessary to completely document the current and correct customs status of the asset has been provided by the broker and is input into BMCS. In one embodiment, this is true of all broker interactions. In one embodiment, the process of creating the Initial Import Package is then complete (block 124).

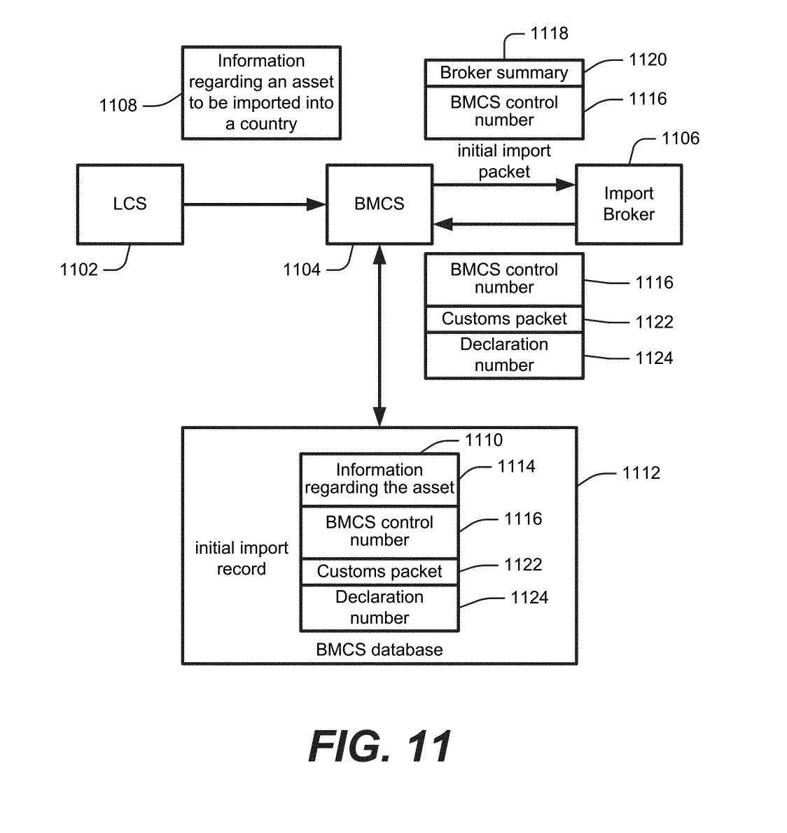

In one embodiment of another view of the initial import process that focuses on the interactions between LCS (e.g., SAP®) 1102, BMCS 1104, and an import broker 1106, illustrated in FIG. 11, BMCS 1104 receives information regarding an asset to be imported into a country 1108 from LCS (e.g., SAP®) 1102. In one embodiment, the “information regarding an asset to be imported into a country” 1108 includes the information shown on the “Equipment” tab (see FIG. 5), the “Material” tab (see FIG. 6), and/or on the “External Material” tab, if such a tab exists.

In one embodiment, BMCS 1104 creates an initial import record 1110 in a BMCS database 1112. In one embodiment, the initial import record 1110 includes information regarding the asset 1114, which in one embodiment is some or all of the “information regarding an asset to be imported into a country” 1108. In one embodiment, the initial import record 1110 includes the unique BMCS control number 1116 generated by the BMCS, as shown in FIG. 8.

In one embodiment, BMCS issues an initial import packet 1118. In one embodiment, the initial import packet 1118 includes a broker summary 1120, such as the “Broker Summary” illustrated in FIG. 9, including a portion of the information regarding the asset 1114 from which a customs packet for import of the asset into the country can be generated. In one embodiment, the initial import packet 1118 includes the BMCS control number 1116.

In one embodiment, the BMCS provides the initial import packet 1118 to an import broker 1106 in the country. In one embodiment, this is done by e-mail as described above.

In one embodiment, the interactions between the import broker 1106 and customs proceed as described above in connection with FIG. 1 resulting in the issuance of customs documents to the broker 1106. In one embodiment, BMCS 1104 receives the following items from the import broker: an electronic version of a customs packet 1122 for the asset, which includes the documents listed on the attachments tab that show that the asset has cleared customs in the country (see FIG. 7) and the “Broker Summary” form illustrated in FIG. 9 with the broker-fillable fields filled in, a declaration number 1124 assigned to the asset by customs in the country, which would be included in one of the broker-fillable fields in the “Broker Summary” form illustrated in FIG. 9, and the BMCS control number.

In response, BMCS 1104 searches the BMCS database 1112 using the BMCS control number 1116 as a key for the search and finds the initial import record 1110. BMCS 1104 then updates the initial import record 1110 with the declaration number 1124 and associates the electronic version of the customs packet for the asset 1122 with the initial import record 1110.

In one embodiment, BMCS determines that the declaration packet is complete, such as by determining that the “Declaration Status” in the “Control Data” tab (FIGS. 4-8, 10) is completed and, in response, the BMCS initiates payment to the import broker 1106.

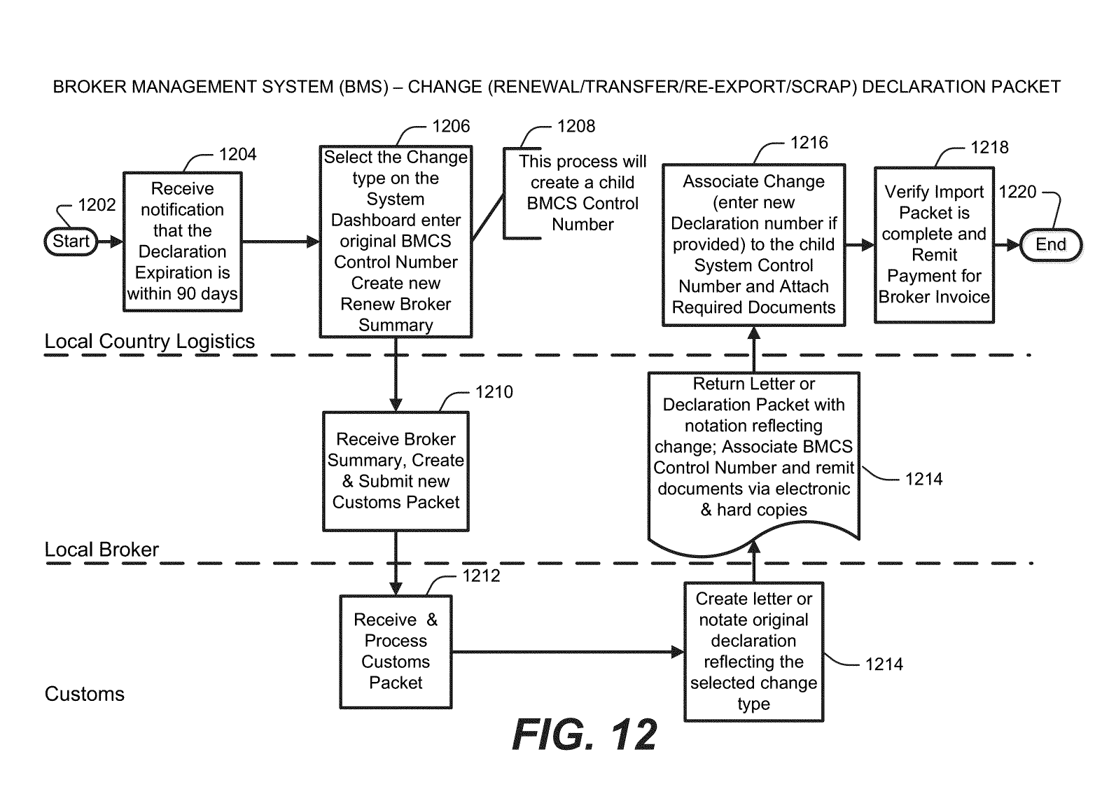

One embodiment of the process for changing (i.e., renewing, transferring, re-exporting, or scrapping) a declaration packet, illustrated in FIG. 12, begins (block 1202) by receiving a notification that the declaration for an asset will expire within 90 days (block 1204).

In one embodiment, the user will access the dashboard illustrated in FIG. 2 and select “Change Declaration Packet,” which will cause a search screen to appear. In one embodiment, the user will enter the original BMCS control number, which will cause information about the original declaration package to appear, and click a button (not shown) to create a new broker summary. In one embodiment, the user will click a button (not shown) to send the broker summary to the broker (block 1206). The BMCS will create a child BMCS control number for the change (block 1208).

The broker will receive the new broker summary and create and submit a new customs packet to customs (block 1210).

Customs will receive and process the customs packet (block 1212) and create a new declaration or notate the original declaration reflecting the selected change type (block 1214) and send it to the broker.

In one embodiment, the broker will return to BMCS the letter or declaration packet with the notation reflecting the change along with the BMCS control number and will remit the customs documents electronically and in hard copy (block 1214).

In one embodiment, BMCS will associate the change (e.g., enter a new declaration number if one is provided) to the child system control number and attach the required documents (block 1216). BMCS will then verify that the import packet is complete and, if only if it is complete, remit payment in response to the broker invoice (block 1218), completing the process (block 1220).

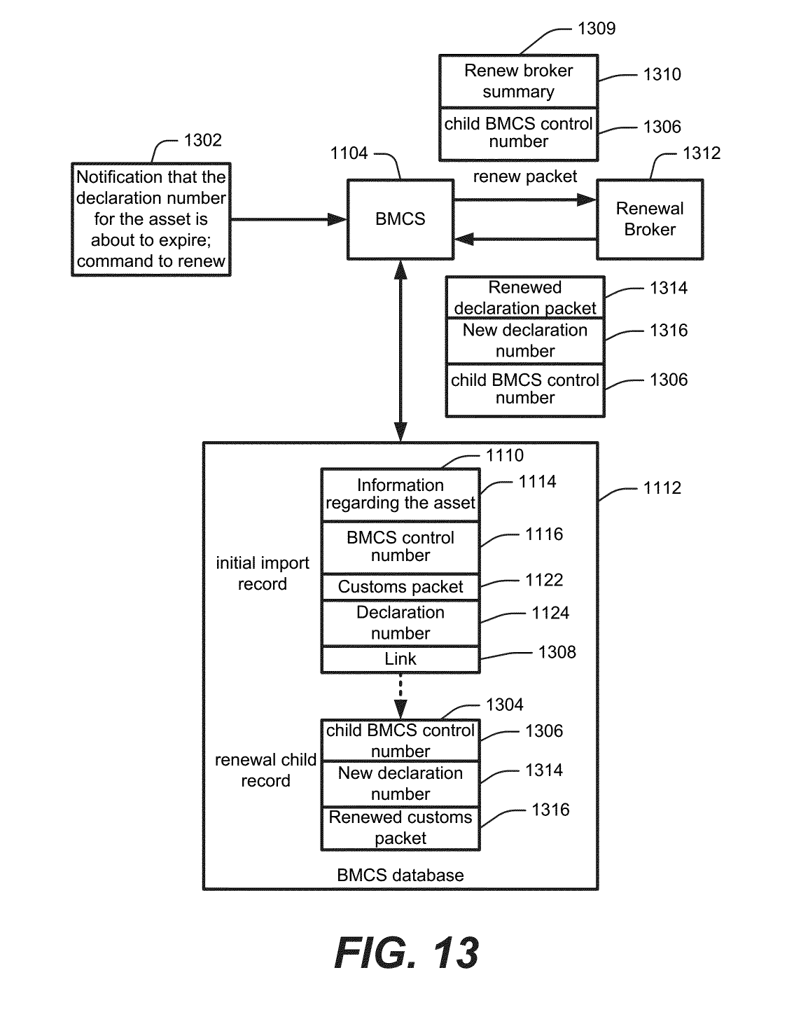

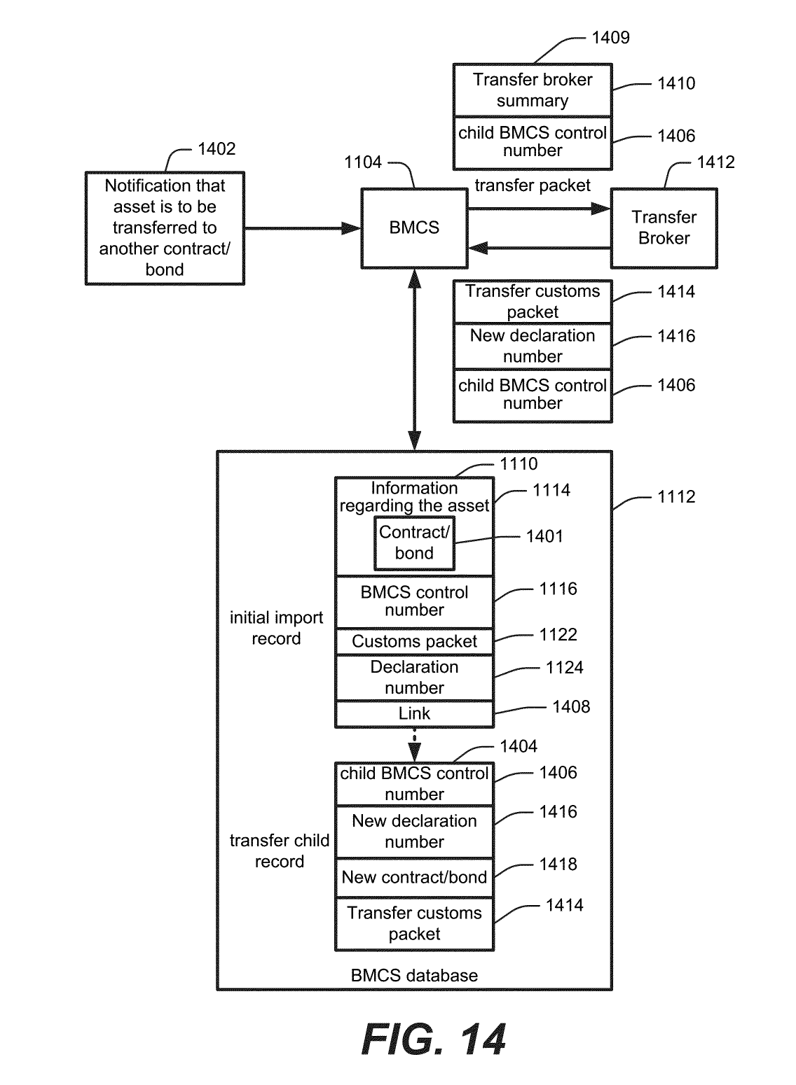

One embodiment of the process for renewing a customs declaration, illustrated in FIG. 13, begins with BMCS receiving a notification that the declaration number for the asset is about to expire (block 1302). In one embodiment, the notification includes the declaration number that is about to expire. In one embodiment, BMCS accesses the initial import record 1110 for the asset using the declaration number for the asset. In one embodiment, BMCS receives a command to renew the import of the asset to the country, for example through the dashboard shown in FIG. 2 and the additional screens discussed above in connection with FIG. 12.

In one embodiment, BMCS 1104 creates a renewal child record 1304 in the BMCS database 1112. In one embodiment, the renewal child record includes a unique child BMCS control number 1306 generated by the BMCS 1104 and a link 1308 to the initial import record for the asset 1110. In one embodiment, the link 1308 is part of the initial import record 1110 rather than the renewal child record 1304.

In one embodiment, BMCS issues a renewal packet 1309 including a renew broker summary 1310 comprising information from which a renewal customs packet for the asset can be generated, and the child BMCS control number 1306. In one embodiment, BMCS provides the renewal packet 1309 to a renewal broker 1312 in the country.

In one embodiment, after the renewal broker 1312 acquires the renewal declaration as described above in connection with FIG. 12, BMCS receives from the renewal broker 1312 an electronic version of a renewed declaration packet for the asset 1314, the renewed customs packet including documents that show that customs declaration for the asset has been renewed, a new declaration number for the asset 1316, and the child BMCS control number 1306.

In one embodiment, BMCS determines that the renewed declaration packet 1314 is complete and, in response updating the renewal child record 1304 with the new declaration number 1316 for the asset, and associating the electronic version of the renewal declaration packet 1316 for the asset with the renewal child record 1304, and initiating payment to the broker.

In one embodiment of the procedure for transferring the asset from one contract/bond to another contract/bond, the information regarding the asset 1114 includes a contract/bond to which the asset is assigned 1401. In one embodiment, BMCS receives a notification that the asset is to be transferred to another contract/bond 1402, the notification 1402 including the BMCS control number for the asset 1116. In one embodiment, BMCS accesses the initial import record 1110 for the asset using the BMCS control number for the asset 1116. In one embodiment, BMCS creates a transfer child record 1404 in the BMCS database 1112. In one embodiment, the transfer child record 1404 includes a unique child BMCS control number 1406 generated by the BMCS 1104 and a link 1408 to the initial import record for the asset. In one embodiment, the link 1408 is part of the initial import record 1110.

In one embodiment, the BMCS 1104 issues a transfer packet 1409 including a transfer broker summary 1410 including information from which a transfer customs packet for the asset can be generated, and the child BMCS control number 1406. In one embodiment, BMCS provides the transfer packet to a transfer broker 1412 in the country.

In one embodiment, after the transfer broker 1412 acquires the renewal declaration as described above in connection with FIG. 12, BMCS 1104 receives from the transfer broker 1412 an electronic version of a transfer customs packet 1414 for the asset, the transfer customs packet including documents that show that customs declaration for the asset has been transferred to the new contract/bond, a new declaration number for the asset 1416, and the child BMCS control number 1406.

In one embodiment, BMCS determines that the transfer customs packet 1414 is complete and, in response, updates the transfer child record 1404 with the new contract/bond 1418 and the declaration number 1416, associates the electronic version of the transfer customs packet 1414 for the asset with the transfer child record 1404, and initiating payment to the transfer broker 1412.

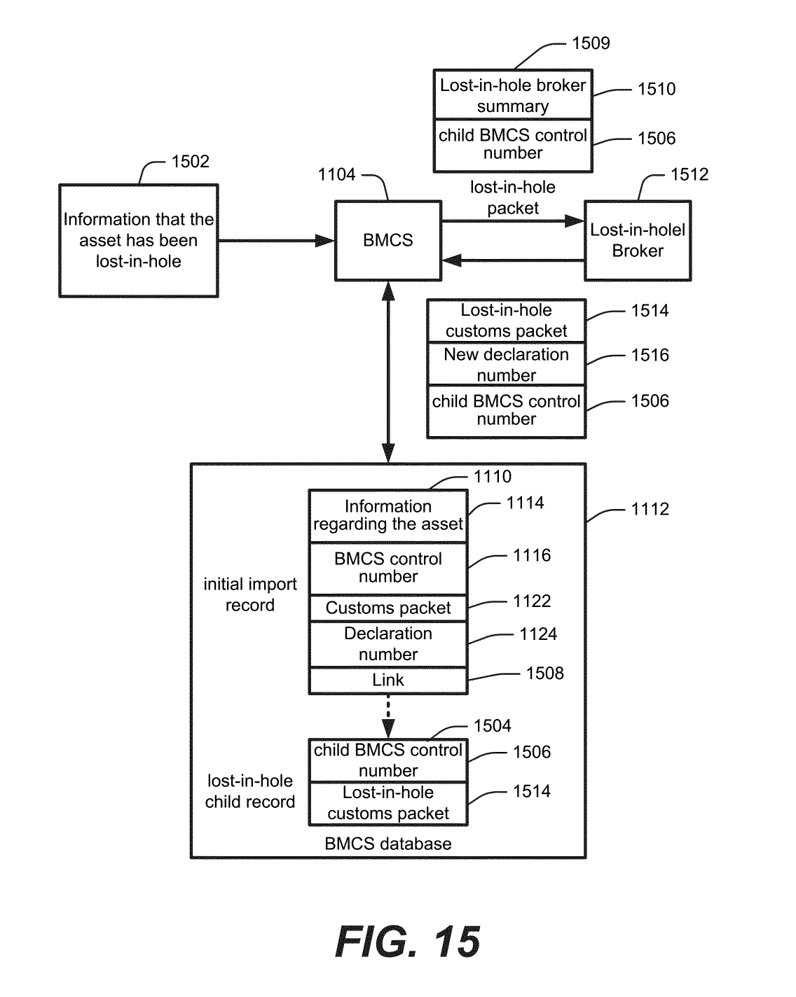

In one embodiment of informing customs that an asset has become lost-in-hole, illustrated in FIG. 15, BMCS 1104 receives a notification 1502 that the asset has been lost-in-hole, the notification 1502 including BMCS control number 1114 for the asset. In one embodiment, BMCS 1104 accesses the initial import record 1110 for the asset using the BMCS control number 1116 for the asset. In one embodiment, BMCS creates a lost-in-hole child record 1504 in the BMCS database 1112. In one embodiment, the lost-in-hole child record 1504 includes a unique child BMCS control number 1506 generated by BMCS 1104 and a link 1508 to the initial import record 1110 for the asset. In one embodiment, the link 1508 is part of the initial import record 1110.

In one embodiment, the BMCS 1104 issues a lost-in-hole packet 1509 including a lost-in-hole broker summary 1510 comprising information from which a lost-in-hole customs packet for the asset can be generated and the child BMCS control number 1506. In one embodiment, BMCS 1104 provides the lost-in-hole packet 1509 to a lost-in-hole broker 1512 in the country.

In one embodiment, after the lost-in-hole broker 1512 acquires the transfer declaration from customs as described above in connection with FIG. 12, BMCS receiving from the lost-in-hole broker 1512 an electronic version of a lost-in-hole customs packet 1514 for the asset, the lost-in-hole customs packet 1514 including documents that show that customs for the country recognizes that the asset has been lost-in-hole, a new declaration number 1516 for the asset, and the child BMCS control number 1506.

In one embodiment, BMCS 1104 determines that the lost-in-hole customs packet 1514 is complete and, in response, associates the electronic version of the lost-in-hole customs packet 1514 for the asset with the lost-in-hole child record 1504, and initiates payment to the lost-in-hole broker 1512.

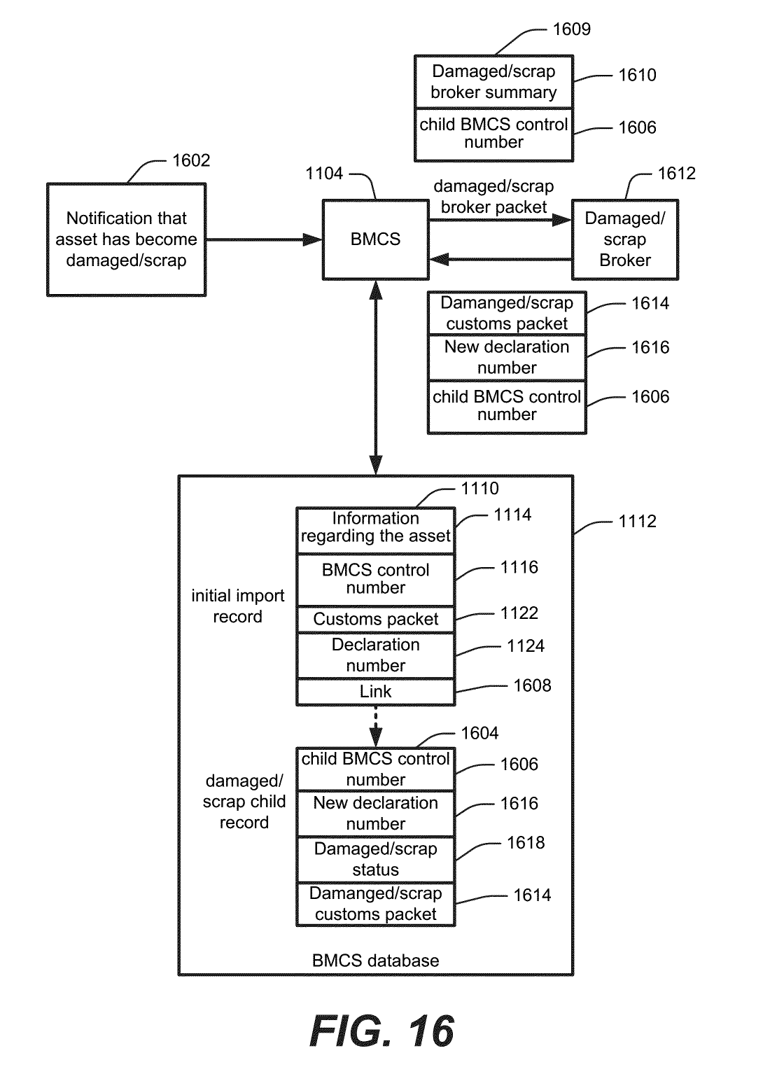

In one embodiment of the process for informing customs that the asset has become damaged or scrap, illustrated in FIG. 16, BMCS 1104 receives a notification 1602 that the asset has become damaged/scrap, the notification including the BMCS control number 1116 for the asset. In one embodiment, BMCS accesses the initial import record 1110 for the asset using the BMCS control number 1116 for the asset. In one embodiment, the BMCS creates a damaged/scrap child record 1604 in the BMCS database 1112. In one embodiment, the damaged/scrap child record 1604 includes a unique child BMCS control number 1606 generated by the BMCS 1104, and a link 1608 to the initial import record 1110 for the asset.

In one embodiment, BMCS 1104 issues a damaged/scrap broker packet 1609 including a damaged/scrap broker summary 1610 including information from which a damaged/scrap customs packet for the asset can be generated, and the child BMCS control number 1606. In one embodiment, BMCS 1104 provides the damaged/scrap packet 1609 to a damaged/scrap broker 1612 in the country.

In one embodiment, after the damaged/scrap broker 1612 acquires the transfer declaration from customs as described above in connection with FIG. 12, BMCS 1104 receives from the damaged/scrap broker 1612 an electronic version of a damaged/scrap customs packet 1614 for the asset, the damaged/scrap customs packet including documents that show that customs for the country recognizes that the asset has become damaged/scrap, a new declaration number 1616 for the asset, and the child BMCS control number 1606.

In one embodiment, BMCS 1104 determines that the damaged/scrap customs packet 1609 is complete and, in response, updates the damaged/scrap child record 1604 to show that the asset is lost-in-hole 1618 and to include the new declaration number 1616. In one embodiment, BMCS 1104 associates the electronic version of the damaged/scrap customs packet 1614 for the asset with the damaged/scrap child record 1604, and initiates payment to the damaged/scrap broker 1612.

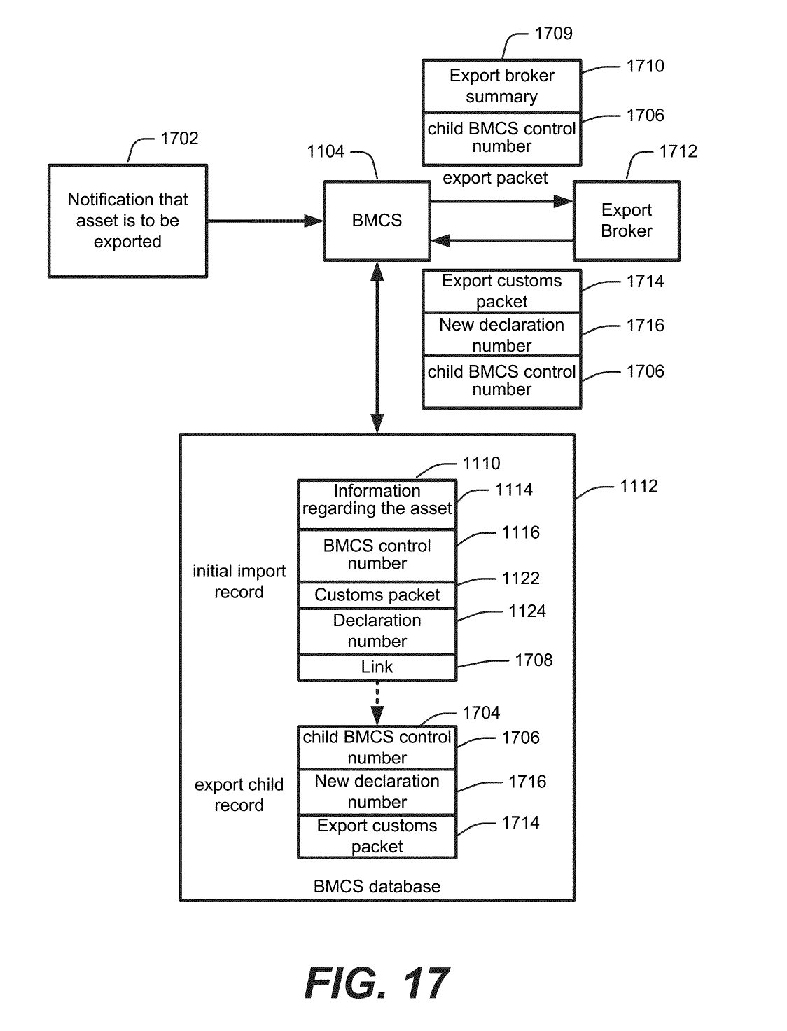

In one embodiment of the process for exporting the asset, illustrated in FIG. 17, BMCS 1104 receives a notification 1702 that the asset is to be exported from the country, the notification including the BMCS control number 1116 for the asset. In one embodiment, BMCS 1104 accesses the initial import record 1110 for the asset using the BMCS control number 1116 for the asset. In one embodiment, BMCS 1104 creates an export child record 1704 in the BMCS database 1112. In one embodiment, the export child record 1704 includes a unique child BMCS control number 1706 generated by the BMCS and a link 1708 to the initial import record for the asset.

In one embodiment, BMCS 1104 issues an export packet 1709 including an export broker summary 1710 comprising information from which an export customs packet for the asset can be generated and the child BMCS control number 1706. In one embodiment, BMCS 1104 provides the export packet to an export broker 1712 in the country.

In one embodiment, after the export broker 1712 acquires the transfer declaration from customs as described above in connection with FIG. 12, BMCS 1104 receives from the export broker an electronic version of an export customs packet 1714 for the asset, the export customs packet including documents that show that customs for the country recognizes that the asset has been exported, a new declaration number 1716 for the asset, and the child BMCS control number 1706.

In one embodiment, BMCS 1104 determines that the export customs packet 1714 is complete and, in response updates the export child record 1704 with the new declaration number 1716, associates the electronic version of the export customs packet for the asset with the export child record, and initiates payment to the export broker 1712.

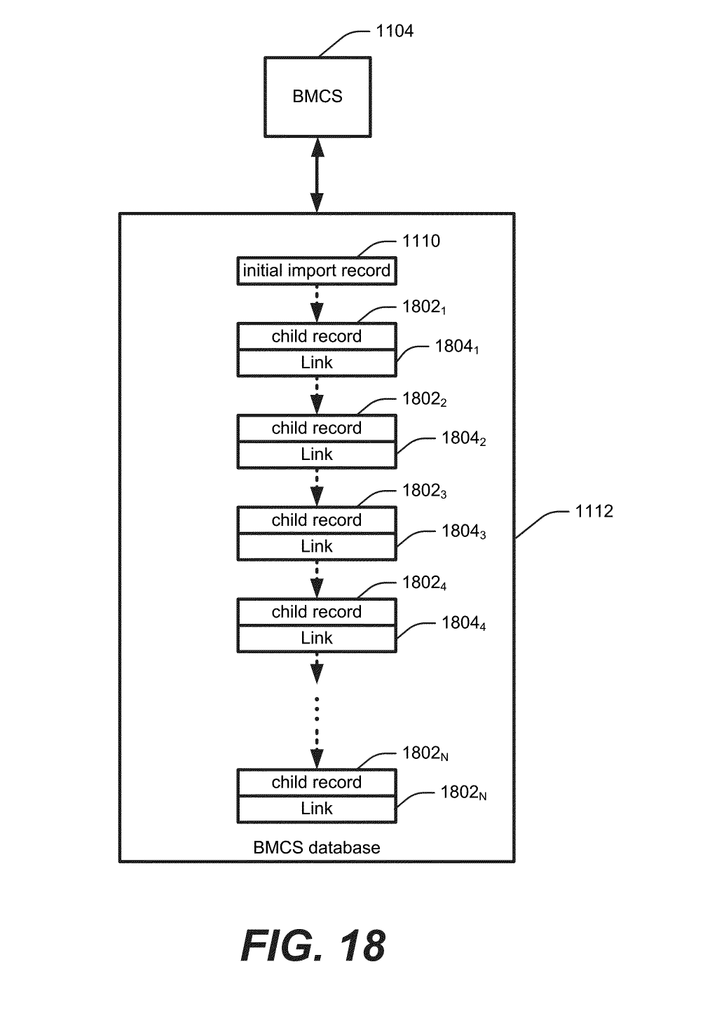

In one embodiment, illustrated in FIG. 18, the initial import record 1110 is linked to a plurality of child records 1802_{1 . . . N} by a linked list, with each child record 1802_{1 . . . N} being linked by a successive link 1804_{1 . . . N} and each child record 1802_{1 . . . N} recording a change in the customs status of the asset. In one embodiment, each child record 1802_{1 . . . N} is linked directly to the initial import record rather than through a linked list.

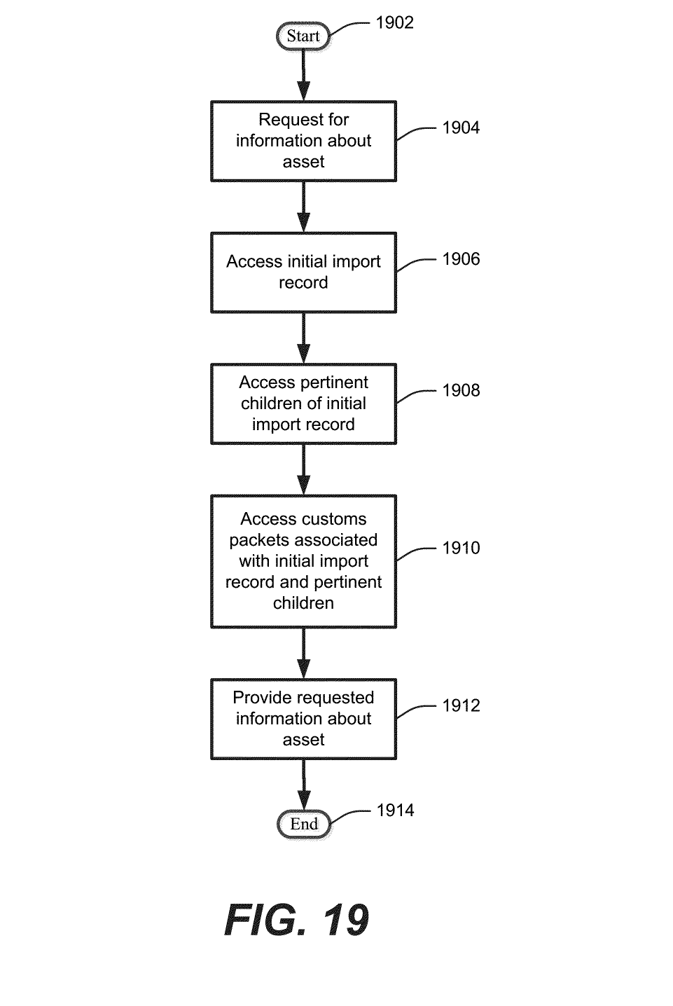

In one embodiment, illustrated in FIG. 19, various reports regarding the import status of assets can be accessed through the “Reports” buttons on the dash board illustrated in FIG. 2. In one embodiment, preparation of a report begins (block 1902) with a request for information about an asset (block 1904). In one embodiment, the initial import record for the asset is accessed (block 1906) using the BMCS control number for the asset, the declaration number, or another key provided by the BMCS database 1112. In one embodiment, pertinent children records of the initial import record are accessed (block 1908). In one embodiment, customs packets associated with the initial import record and the pertinent children are accessed (block 1910). In one embodiment, the information requested about the asset is provided in the form of a report (block 1912) and the process ends (block 1914).

The text above describes one or more specific embodiments of a broader invention. The invention also is carried out in a variety of alternate embodiments and thus is not limited to those described here. The foregoing description of an embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method comprising:
a broker management computer system (“BMCS”) receiving from a logistics computer system (“LCS”) information regarding an asset to be imported into a country;
the BMCS creating an initial import record in a BMCS database, the initial import record comprising:
information regarding the asset, and
a unique BMCS control number generated by the BMCS;
the BMCS issuing an initial import packet comprising:
a broker summary comprising a portion of the information regarding the asset from which a customs packet for import of the asset into the country can be generated, and
the BMCS control number;
the BMCS providing the initial import packet to an import broker in the country;
the BMCS receiving from the import broker:
an electronic version of a customs packet for the asset, the customs packet including documents that show that the asset has cleared customs in the country,
a declaration number assigned to the asset by customs in the country, and the BMCS control number;
and, in response, the BMCS:
searching the BMCS database using the BMCS control number as a key for the search and finding the initial import record;
updating the initial import record with the declaration number,
associating the electronic version of the customs packet for the asset with the initial import record, and
determining that the declaration packet is complete and, in response, initiating payment to the import broker.

2. The method of claim 1 further comprising:
the BMCS receiving a notification that the declaration number for the asset is about to expire;
the BMCS accessing the initial import record for the asset using the declaration number for the asset;
the BMCS receiving a command to renew the import of the asset to the country;
the BMCS creating a renewal child record in the BMCS database, the renewal child record comprising:
a unique child BMCS control number generated by the BMCS, and
a link to the initial import record for the asset;
the BMCS issuing a renewal packet comprising:
a renew broker summary comprising information from which a renewal customs packet for the asset can be generated, and
the child BMCS control number;
the BMCS providing the renewal packet to a renewal broker in the country;
the BMCS receiving from the renewal broker:
an electronic version of a renewed customs packet for the asset, the renewed customs packet including documents that show that customs declaration for the asset has been renewed,
a new declaration number for the asset, and
the child BMCS control number;
the BMCS determining that the renewed declaration packet is complete and, in response:
updating the renewal child record with the new declaration number for the asset, and
associating the electronic version of the renewal declaration packet for the asset with the renewal child record; and
initiating payment to the renewal broker.

3. The method of claim 1 further comprising:
the BMCS receiving a command to create an import package selected from the group consisting of a definitive import package, a temporary import package, a temporary export package, a bonded import package, and an update pending packet package.

4. The method of claim 1 wherein the information regarding the asset comprises a contract/bond to which the asset is assigned, the method further comprising:
the BMCS receiving a notification that the asset is to be transferred to another contract/bond, the notification including the BMCS control number for the asset;
the BMCS accessing the initial import record for the asset using the BMCS control number for the asset;
the BMCS creating a transfer child record in the BMCS database, the transfer child record comprising:
a unique child BMCS control number generated by the BMCS, and
a link to the initial import record for the asset;
the BMCS issuing a transfer packet comprising:
a transfer broker summary comprising information from which a transfer customs packet for the asset can be generated, and
the child BMCS control number;
the BMCS providing the transfer packet to a transfer broker in the country;
the BMCS receiving from the transfer broker:
an electronic version of a transfer customs packet for the asset, the transfer customs packet including documents that show that customs declaration for the asset has been transferred to the new contract/bond,
a new declaration number for the asset, and
the child BMCS control number;
the BMCS determining that the transfer customs packet is complete and, in response:
updating the transfer child record with the new contract/bond and the declaration number,
associating the electronic version of the transfer customs packet for the asset with the transfer child record, and
initiating payment to the transfer broker.

5. The method of claim 1 further comprising:
the BMCS receiving a notification that the asset has been lost-in-hole, the notification including the BMCS control number for the asset;
the BMCS accessing the initial import record for the asset using the BMCS control number for the asset;
the BMCS creating a lost-in-hole child record in the BMCS database, the lost-in-hole child record comprising:
a unique child BMCS control number generated by the BMCS, and
a link to the initial import record for the asset;
the BMCS issuing a lost-in-hole packet comprising:
a lost-in-hole broker summary comprising information from which a lost-in-hole customs packet for the asset can be generated, and
the child BMCS control number;
the BMCS providing the lost-in-hole packet to a lost-in-hole broker in the country;
the BMCS receiving from the lost-in-hole broker:
an electronic version of a lost-in-hole customs packet for the asset, the lost-in-hole customs packet including documents that show that customs for the country recognizes that the asset has been lost-in-hole,
a new declaration number for the asset, and
the child BMCS control number;
the BMCS determining that the lost-in-hole customs packet is complete and, in response:
associating the electronic version of the lost-in-hole customs packet for the asset with the lost-in-hole child record, and
initiating payment to the lost-in-hole broker.

6. The method of claim 1 further comprising:
the BMCS receiving a notification that the asset has become damaged/scrap, the notification including the BMCS control number for the asset;
the BMCS accessing the initial import record for the asset using the BMCS control number for the asset;
the BMCS creating a damaged/scrap child record in the BMCS database, the damaged/scrap child record comprising:
a unique child BMCS control number generated by the BMCS, and
a link to the initial import record for the asset;
the BMCS issuing a damaged/scrap broker packet comprising:
a damaged/scrap broker summary comprising information from which a damaged/scrap customs packet for the asset can be generated, and
the child BMCS control number;
the BMCS providing the damaged/scrap packet to a damaged/scrap broker in the country;
the BMCS receiving from the damaged/scrap broker:
an electronic version of a damaged/scrap customs packet for the asset, the damaged/scrap customs packet including documents that show that customs for the country recognizes that the asset has become damaged/scrap
a new declaration number for the asset, and
the child BMCS control number;
the BMCS determining that the damaged/scrap customs packet is complete and, in response:
updating the damaged/scrap child record to show that the asset is lost-in-hole and to include the new declaration number,
associating the electronic version of the damaged/scrap customs packet for the asset with the damaged/scrap child record, and
initiating payment to the damaged/scrap broker.

7. The method of claim 1 further comprising:
the BMCS receiving a notification that the asset is to be exported from the country, the notification including the BMCS control number for the asset;
the BMCS accessing the initial import record for the asset using the BMCS control number for the asset;
the BMCS creating an export child record in the BMCS database, the export child record comprising:
a unique child BMCS control number generated by the BMCS, and
a link to the initial import record for the asset;
the BMCS issuing an export packet comprising:
an export broker summary comprising information from which an export customs packet for the asset can be generated,
the child BMCS control number;
the BMCS providing the export packet to an export broker in the country;
the BMCS receiving from the export broker:
an electronic version of an export customs packet for the asset, the export customs packet including documents that show that customs for the country recognizes that the asset has been exported,
a new declaration number for the asset, and
the child BMCS control number;
the BMCS determining that the export customs packet is complete and, in response:
updating the export child record with the new declaration number,
associating the electronic version of the export customs packet for the asset with the export child record, and
initiating payment to the export broker.

8. The method of claim 1 further comprising:
linking the initial import record to a plurality of child records by a linked list, each child record recording a change in the customs status of the asset.

9. The method of claim 1 further comprising:
the BMCS querying the LCS for information regarding the asset, the querying being keyed on a key selected from the group consisting of a document number, an invoice number, a shipment number, a purchase order number, and an external reference.

10. The method of claim 1 further comprising:
the BMCS receiving a specification of an import category selected from the group consisting of a bonded import, a definitive import, and a temporary import.

11. A computer program stored in a non-transitory computer readable storage medium, the program comprising executable instructions that cause a broker management computer system (“BMCS”) to:
receive from a logistics computer system (“LCS”) information regarding an asset to be imported into a country;
create an initial import record in a BMCS database, the initial import record comprising:
information regarding the asset, and
a unique BMCS control number generated by the BMCS;
issue an initial import packet comprising:
a broker summary comprising a portion of the information regarding the asset from which a customs packet for import of the asset into the country can be generated, and
the BMCS control number;
provide the initial import packet to an import broker in the country;
receive from the import broker:
an electronic version of a customs packet for the asset, the customs packet including documents that show that the asset has cleared customs in the country,
a declaration number assigned to the asset by customs in the country, and
the BMCS control number;
and, in response:
search the BMCS database using the BMCS control number as a key for the search and finding the initial import record;
update the initial import record with the declaration number,
associate the electronic version of the customs packet for the asset with the initial import record, and
determine that the declaration packet is complete and, in response, initiating payment to the import broker.

12. The computer program of claim 11 further comprising executable instructions that cause the BMCS to:
receive a notification that the declaration number for the asset is about to expire;
access the initial import record for the asset using the declaration number for the asset;
receive a command to renew the import of the asset to the country;
create a renewal child record in the BMCS database, the renewal child record comprising:
a unique child BMCS control number generated by the BMCS, and
a link to the initial import record for the asset;
issue a renewal packet comprising:
a renew broker summary comprising information from which a renewal customs packet for the asset can be generated, and
the child BMCS control number;
provide the renewal packet to a renewal broker in the country;
receive from the renewal broker:
an electronic version of a renewed customs packet for the asset, the renewed customs packet including documents that show that customs declaration for the asset has been renewed,
a new declaration number for the asset, and
the child BMCS control number;
determine that the renewed declaration packet is complete and, in response:
update the renewal child record with the new declaration number for the asset, and
associate the electronic version of the renewal declaration packet for the asset with the renewal child record; and
initiate payment to the renewal broker.

13. The computer program of claim 11 further comprising executable instructions that cause the BMCS to:
receive a command to create an import package selected from the group consisting of a definitive import package, a temporary import package, a temporary export package, a bonded import package, and an update pending packet package.

14. The computer program of claim 11 wherein the information regarding the asset comprises a contract/bond to which the asset is assigned, the computer program further comprising executable instructions that cause the BMCS to:
receive a notification that the asset is to be transferred to another contract/bond, the notification including the BMCS control number for the asset;
access the initial import record for the asset using the BMCS control number for the asset;
create a transfer child record in the BMCS database, the transfer child record comprising:
a unique child BMCS control number generated by the BMCS, and
a link to the initial import record for the asset;
issue a transfer packet comprising:
a transfer broker summary comprising information from which a transfer customs packet for the asset can be generated, and
the child BMCS control number;
provide the transfer packet to a transfer broker in the country;
receive from the transfer broker:
an electronic version of a transfer customs packet for the asset, the transfer customs packet including documents that show that customs declaration for the asset has been transferred to the new contract/bond,
a new declaration number for the asset, and
the child BMCS control number;
determine that the transfer customs packet is complete and, in response:
updating the transfer child record with the new contract/bond and the declaration number,
associating the electronic version of the transfer customs packet for the asset with the transfer child record, and
initiate payment to the transfer broker.

15. The computer program of claim 11 further comprising executable instructions that cause the BMCS to:
receive a notification that the asset has been lost-in-hole, the notification including the BMCS control number for the asset;
access the initial import record for the asset using the BMCS control number for the asset;
create a lost-in-hole child record in the BMCS database, the lost-in-hole child record comprising:
a unique child BMCS control number generated by the BMCS, and
a link to the initial import record for the asset;
issue a lost-in-hole packet comprising:
a lost-in-hole broker summary comprising information from which a lost-in-hole customs packet for the asset can be generated, and
the child BMCS control number;
provide the lost-in-hole packet to a lost-in-hole broker in the country;
receive from the lost-in-hole broker:
an electronic version of a lost-in-hole customs packet for the asset, the lost-in-hole customs packet including documents that show that customs for the country recognizes that the asset has been lost-in-hole,
a new declaration number for the asset, and
the child BMCS control number;
determine that the lost-in-hole customs packet is complete and, in response:
associating the electronic version of the lost-in-hole customs packet for the asset with the lost-in-hole child record, and
initiate payment to the lost-in-hole broker.

16. The computer program of claim 11 further comprising executable instructions that cause the BMCS to:
receive a notification that the asset has become damaged/scrap, the notification including the BMCS control number for the asset;
access the initial import record for the asset using the BMCS control number for the asset;
create a damaged/scrap child record in the BMCS database, the damaged/scrap child record comprising:
a unique child BMCS control number generated by the BMCS, and
a link to the initial import record for the asset;
issue a damaged/scrap broker packet comprising:
a damaged/scrap broker summary comprising information from which a damaged/scrap customs packet for the asset can be generated, and
the child BMCS control number;
provide the damaged/scrap packet to a damaged/scrap broker in the country;
receive from the damaged/scrap broker:
an electronic version of a damaged/scrap customs packet for the asset, the damaged/scrap customs packet including documents that show that customs for the country recognizes that the asset has become damaged/scrap
a new declaration number for the asset, and
the child BMCS control number;
determine that the damaged/scrap customs packet is complete and, in response:
update the damaged/scrap child record to show that the asset is lost-in-hole and to include the new declaration number,
associate the electronic version of the damaged/scrap customs packet for the asset with the damaged/scrap child record, and
initiate payment to the damaged/scrap broker.

17. The computer program of claim 11 further comprising executable instructions that cause the BMCS to:
receive a notification that the asset is to be exported from the country, the notification including the BMCS control number for the asset;
access the initial import record for the asset using the BMCS control number for the asset;
create an export child record in the BMCS database, the export child record comprising:
a unique child BMCS control number generated by the BMCS, and
a link to the initial import record for the asset;
issue an export packet comprising:
an export broker summary comprising information from which an export customs packet for the asset can be generated,
the child BMCS control number;
provide the export packet to an export broker in the country;
receive from the export broker:
an electronic version of an export customs packet for the asset, the export customs packet including documents that show that customs for the country recognizes that the asset has been exported,
a new declaration number for the asset, and
the child BMCS control number;
determine that the export customs packet is complete and, in response:
update the export child record with the new declaration number,
associate the electronic version of the export customs packet for the asset with the export child record, and
initiate payment to the export broker.

18. A computer system for managing customs information comprising:
an interface to a Logistics Computer System (“LCS”) from which information about items to be imported can be accessed;
an interface to a Broker Management Computer System (“BMCS”) database storing the import/export history of an asset; and
an interface to a import broker.

19. The computer system of claim 18 wherein:
the BMCS database stores the import/export history of the asset in records keyed to a unique BMCS control number.

20. The computer system of claim 18 wherein:
the BMCS database stores the import/export history of the asset in asset records along with other-asset records of assets imported at the same time as the asset in which the asset records and the other-asset records are keyed to the unique BMCS control number.
